(19) United States
(12) Patent Application Publication
(10) Pub. No.: US 2026/0031947 A1
(43) Pub. Date: Jan. 29, 2026

(54) PARALLEL PROCESSING FOR MACHINE LEARNING-BASED CHANNEL STATE INFORMATION REPORTS

(71) Applicant: Google LLC, Mountain View, CA (US)

(72) Inventors: Yushu Zhang, Beijing (CN); Chih-Hsiang Wu, Taipei City (TW)

(21) Appl. No.: 18/994,546

(22) PCT Filed: Jul. 5, 2023
(86) PCT No.: PCT/CN2023/105797

§ 371 Date: Jan. 14, 2025

(30) Foreign Application Priority Data
Aug. 12, 2022 (WO) PCT/CN2022/112193

(51) Int. Cl. H04L 5/00

(52) U.S. Cl. CPC H04L 5/0048

(57) ABSTRACT

This disclosure provides systems, devices, apparatus, and methods, including computer programs encoded on storage media, for parallel processing and processing delays of ML-based CSI reports. A UE receives (404, 804), from a network entity (104), a configuration for an ML-based CSI report associated with a first CSI-RS. The UE (102) receives (407, 807), from the network entity (104), the first CSI-RS and transmits (412, 812), to the network entity (104), the ML-based CSI report including CSI that is based on a UE capability for processing the ML-based CSI report in association with the first CSI-RS.

### CROSS REFERENCE TO RELATED APPLICATION(S)

This application claims the benefit of and priority to International Application No. PCT/CN2022/112193, entitled “CSI Reports based on ML Techniques” and filed on Aug. 12, 2022, which is expressly incorporated by reference herein in its entirety.

### TECHNICAL FIELD

The present disclosure relates generally to wireless communication, and more particularly, to channel state information (CSI) reports based on machine learning (ML) techniques.

### BACKGROUND

The Third Generation Partnership Project (3GPP) specifies a radio interface referred to as fifth generation (5G) new radio (NR) (5G NR). An architecture for a 5G NR wireless communication system includes a 5G core (5GC) network, a 5G radio access network (5G-RAN), a user equipment (UE), etc. The 5G NR architecture seeks to provide increased data rates, decreased latency, and/or increased capacity compared to prior generation cellular communication systems.

Wireless communication systems, in general, provide various telecommunication services (e.g., telephony, video, data, messaging, broadcasts, etc.) based on multiple-access technologies, such as orthogonal frequency division multiple access (OFDMA) technologies, that support communication with multiple UEs. Improvements in mobile broadband continue the progression of such wireless communication technologies. For example, UEs and base stations can support more antenna configurations and multi-connectivity. One consequence, however, is that channel state information (CSI) reports have become larger and more complex.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

A user equipment (UE) may receive one or more channel state information-reference signals (CSI-RSs) from a network entity, such as a base station or a unit of a base station. The UE uses the received CSI-RSs to generate one or more channel state information (CSI) reports. In some cases, the UE may generate one or more CSI reports based on at least one machine learning (ML) model. Hence, the UE may include a first UE capability for parallel processing of a plurality of CSI reports based on ML model(s) and/or a second UE capability for parallel processing of a first CSI report based on the ML model(s) and a second CSI report that is not based on the ML model(s).

The UE may indicate a capability of the UE for parallel processing in a UE capability report transmitted to the network entity. However, the parallel processing capability of the UE is limited to a maximum number of CSI processing units (CPUs), such as when the UE performs ML-based CSI report processing based on Type 2 CPUs. A “Type 2 CPU”, as used herein, refers to a CPU that is used for an ML-based CSI report processing procedure, but is not shared with/used for a non-ML-based CSI report processing procedure. Shared CPUs with the non-ML-based CSI report processing procedure are referred to herein as “Type 1 CPUs.” In order to comply with limitations on the number of CPUs used for the CSI reports (e.g., the number of CPUs being less than or equal to the maximum number of CPUs associated with the UE capability), the UE may measure/report the CSI for high priority ML-based/non-ML-based CSI reports, but report previously measured CSI (e.g., outdated CSI) for low priority ML-based/non-ML-based CSI reports.

According to some aspects, the UE receives, from the network entity, a configuration for an ML-based CSI report associated with a first CSI-RS. The UE receives, from the network entity, the first CSI-RS and transmits, to the network entity, the ML-based CSI report including CSI that is based on a UE capability for processing the ML-based CSI report in association with the first CSI-RS.

According to some aspects, a network entity transmits, to the UE, the configuration for the ML-based CSI report associated with the first CSI-RS. The network entity transmits, to the UE, the first CSI-RS and receives, from the UE, the ML-based CSI report including CSI that is based on a UE capability for processing the ML-based CSI report in association with the first CSI-RS.

### BRIEF DESCRIPTION OF THE DRAWINGS

FIG. 1 illustrates a diagram of a wireless communications system including a plurality of user equipments (UEs) and network entities in communication over one or more cells.

FIG. 2 illustrates a diagram for example machine learning (ML)-based channel state information (CSI) encoder compression at a UE and example ML-based CSI decoder decompression at a network entity.

FIG. 3A illustrates a first timing diagram for a first CSI processing unit (CPU) duration associated with periodic/semi-persistent CSI reporting.

FIG. 3B illustrates a second timing diagram for a second CPU duration associated with aperiodic CSI reporting.

FIG. 4 is a signaling diagram illustrating an ML-based CSI processing procedure.

FIG. 5 illustrates a timing diagram for Type 2 CPU occupancy.

FIGS. 6A-6B illustrate example timing diagrams of CPU occupancy for an ML-based periodic/semi-persistent CSI report.

FIGS. 7A-7B illustrate example timing diagrams of CPU occupancy for an ML-based aperiodic CSI report.

FIG. 8 illustrates a signaling diagram for CSI reporting based on a minimum processing delay.

FIG. 9 is a flowchart of a method of wireless communication at a UE.

FIG. 10 is a flowchart of a method of wireless communication at a network entity.

FIG. 11 is a diagram illustrating an example of a hardware implementation for an example UE apparatus.

FIG. 12 is a diagram illustrating an example of a hardware implementation for one or more example network entities.

### DETAILED DESCRIPTION

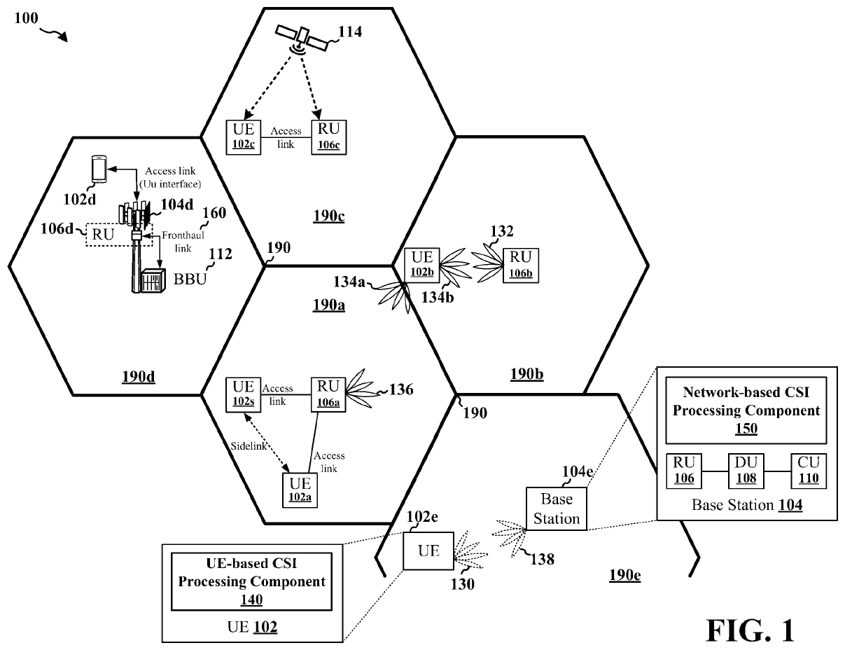

FIG. 1 illustrates a diagram 100 of a wireless communications system associated with a plurality of cells 190. The wireless communications system includes user equipments (UEs) 102 and base stations/network entities 104. Some base stations may include an aggregated base station architecture and other base stations may include a disaggregated base station architecture. The aggregated base station architecture utilizes a radio protocol stack that is physically or logically integrated within a single radio access network (RAN) node. A disaggregated base station architecture utilizes a protocol stack that is physically or logically distributed among two or more units (e.g., radio unit (RU) 106, distributed unit (DU) 108, central unit (CU) 110). For example, a CU 110 is implemented within a RAN node, and one or more DUs 108 may be co-located with the CU 110, or alternatively, may be geographically or virtually distributed throughout one or multiple other RAN nodes. The DUs 108 may be implemented to communicate with one or more RUs 106. Any of the RU 106, the DU 108 and the CU 110 can be implemented as virtual units, such as a virtual radio unit (VRU), a virtual distributed unit (VDU), or a virtual central unit (VCU). The base station/network entity 104 (e.g., an aggregated base station or disaggregated units of the base station, such as the RU 106 or the DU 108), may be referred to as a transmission reception point (TRP).

Operations of the base station 104 and/or network designs may be based on aggregation characteristics of base station functionality. For example, disaggregated base station architectures are utilized in an integrated access backhaul (IAB) network, an open-radio access network (O-RAN) network, or a virtualized radio access network (vRAN), which may also be referred to a cloud radio access network (C-RAN). Disaggregation may include distributing functionality across the two or more units at various physical locations, as well as distributing functionality for at least one unit virtually, which can enable flexibility in network designs. The various units of the disaggregated base station architecture, or the disaggregated RAN architecture, can be configured for wired or wireless communication with at least one other unit. For example, the base stations 104d/104e and/or the RUs 106a-106d may communicate with the UEs 102a-102d and 102s via one or more radio frequency (RF) access links based on a Uu interface. In examples, multiple RUs 106 and/or base stations 104 may simultaneously serve the UEs 102, such as by intra-cell and/or inter-cell access links between the UEs 102 and the RUs 106/base stations 104.

The RU 106, the DU 108, and the CU 110 may include (or may be coupled to) one or more interfaces configured to transmit or receive information/signals via a wired or wireless transmission medium. For example, a wired interface can be configured to transmit or receive the information/signals over a wired transmission medium, such as via the fronthaul link 160 between the RU 106d and the baseband unit (BBU) 112 of the base station 104d associated with the cell 190d. The BBU 112 includes a DU 108 and a CU 110, which may also have a wired interface (e.g., midhaul link) configured between the DU 108 and the CU 110 to transmit or receive the information/signals between the DU 108 and the CU 110. In further examples, a wireless interface, which may include a receiver, a transmitter, or a transceiver, such as an RF transceiver, configured to transmit and/or receive the information/signals via the wireless transmission medium, such as for information communicated between the RU 106a of the cell 190a and the base station 104e of the cell 190e via cross-cell communication beams 136-138 of the RU 106a and the base station 104e.

The RUs 106 may be configured to implement lower layer functionality. For example, the RU 106 is controlled by the DU 108 and may correspond to a logical node that hosts RF processing functions, or lower layer PHY functionality, such as execution of fast Fourier transform (FFT), inverse FFT (IFFT), digital beamforming, physical random access channel (PRACH) extraction and filtering, etc. The functionality of the RU 106 may be based on the functional split, such as a functional split of lower layers.

The RUs 106 may transmit or receive over-the-air (OTA) communication with one or more UEs 102. For example, the RU 106b of the cell 190b communicates with the UE 102b of the cell 190b via a first set of communication beams 132 of the RU 106b and a second set of communication beams 134b of the UE 102b, which may correspond to inter-cell communication beams or, in some examples, cross-cell communication beams. For instance, the UE 102b of the cell 190b may communicate with the RU 106a of the cell 190a via a third set of communication beams 134a of the UE 102b and a fourth set of communication beams 136 of the RU 106a. DUs 108 can control both real-time and non-real-time features of control plane and user plane communications of the RUs 106.

Any combination of the RU 106, the DU 108, and the CU 110, or reference thereto individually, may correspond to a base station 104. Thus, the base station 104 may include at least one of the RU 106, the DU 108, or the CU 110. The base stations 104 provide the UEs 102 with access to a core network. The base stations 104 may relay communications between the UEs 102 and the core network (not shown). The base stations 104 may be associated with macrocells for higher-power cellular base stations and/or small cells for lower-power cellular base stations. For example, the cell 190e may correspond to a macrocell, whereas the cells 190a-190d may correspond to small cells. Small cells include femtocells, picocells, microcells, etc. A network that includes at least one macrocell and at least one small cell may be referred to as a “heterogeneous network.”

Transmissions from a UE 102 to a base station 104/RU 106 are referred to as uplink (UL) transmissions, whereas transmissions from the base station 104/RU 106 to the UE 102 are referred to as downlink (DL) transmissions. Uplink transmissions may also be referred to as reverse link transmissions and downlink transmissions may also be referred to as forward link transmissions. For example, the RU 106d utilizes antennas of the base station 104d of cell 190d to transmit a downlink/forward link communication to the UE 102d or receive an uplink/reverse link communication from the UE 102d based on the Uu interface associated with the access link between the UE 102d and the base station 104d/RU 106d.

Communication links between the UEs 102 and the base stations 104/RUs 106 may be based on multiple-input and multiple-output (MIMO) antenna technology, including spatial multiplexing, beamforming, and/or transmit diversity. The communication links may be associated with one or more carriers. The UEs 102 and the base stations 104/RUs 106 may utilize a spectrum bandwidth of Y MHz (e.g., 5, 10, 15, 20, 100, 400, 800, 1600, 2000, etc. MHz) per carrier allocated in a carrier aggregation of up to a total of Yx MHz, where x component carriers (CCs) are used for communication in each of the uplink and downlink directions. The carriers may or may not be adjacent to each other along a frequency spectrum. In examples, uplink and downlink carriers may be allocated in an asymmetric manner, with more or fewer carriers allocated to either the uplink or the downlink. A primary component carrier and one or more secondary component carriers may be included in the component carriers. The primary component carrier may be associated with a primary cell (PCell) and a secondary component carrier may be associated with a secondary cell (SCell).

Some UEs 102, such as the UEs 102a and 102s, may perform device-to-device (D2D) communications over sidelink. For example, a sidelink communication/D2D link utilizes a spectrum for a wireless wide area network (WWAN) associated with uplink and downlink communications. Such sidelink/D2D communication may be performed through various wireless communications systems, such as wireless fidelity (Wi-Fi) systems, Bluetooth systems, Long Term Evolution (LTE) systems, New Radio (NR) systems, etc.

The UEs 102 and the base stations 104/RUs 106 may each include a plurality of antennas. The plurality of antennas may correspond to antenna elements, antenna panels, and/or antenna arrays that may facilitate beamforming operations. For example, the RU 106b transmits a downlink beamformed signal based on a first set of communication beams 132 to the UE 102b in one or more transmit directions of the RU 106b. The UE 102b may receive the downlink beamformed signal based on a second set of communication beams 134b from the RU 106b in one or more receive directions of the UE 102b. In a further example, the UE 102b may also transmit an uplink beamformed signal (e.g., sounding reference signal (SRS)) to the RU 106b based on the second set of communication beams 134b in one or more transmit directions of the UE 102b. The RU 106b may receive the uplink beamformed signal from the UE 102b in one or more receive directions of the RU 106b. The UE 102b may perform beam training to determine the best receive and transmit directions for the beamformed signals. The transmit and receive directions for the UEs 102 and the base stations 104/RUs 106 may or may not be the same.

In further examples, beamformed signals may be communicated between a first base station/RU 106a and a second base station 104e. For instance, the base station 104e of the cell 190e may transmit a beamformed signal to the RU 106a based on the communication beams 138 in one or more transmit directions of the base station 104e. The RU 106a may receive the beamformed signal from the base station 104e of the cell 190e based on the RU communication beams 136 in one or more receive directions of the RU 106a. In further examples, the base station 104e transmits a downlink beamformed signal to the UE 102e based on the communication beams 138 in one or more transmit directions of the base station 104e. The UE 102e receives the downlink beamformed signal from the base station 104e based on UE communication beams 130 in one or more receive directions of the UE 102e. The UE 102e may also transmit an uplink beamformed signal to the base station 104e based on the UE communication beams 130 in one or more transmit directions of the UE 102e, such that the base station 104e may receive the uplink beamformed signal from the UE 102e in one or more receive directions of the base station 104e.

The base station 104 may include and/or be referred to as a network entity. That is, “network entity” may refer to the base station 104 or at least one unit of the base station 104, such as the RU 106, the DU 108, and/or the CU 110. The base station 104 may also include and/or be referred to as a next generation evolved Node B (ng-eNB), a next generation NB (gNB), an evolved NB (eNB), an access point, a base transceiver station, a radio base station, a radio transceiver, a transceiver function, a basic service set (BSS), an extended service set (ESS), a TRP, a network node, network equipment, or other related terminology. The base station 104 or an entity at the base station 104 can be implemented as an IAB node, a relay node, a sidelink node, an aggregated (monolithic) base station, or a disaggregated base station including one or more RUs 106, DUs 108, and/or CUs 110. A set of aggregated or disaggregated base stations may be referred to as a next generation-radio access network (NG-RAN). In some examples, the UE 102a operates in dual connectivity (DC) with the base station 104e and the base station/RU 106a. In such cases, the base station 104e can be a master node and the base station/RU 160a can be a secondary node.

Uplink/downlink signaling may also be communicated via a satellite positioning system (SPS) 114. In an example, the SPS 114 of the cell 190c may be in communication with one or more UEs 102, such as the UE 102c, and one or more base stations 104/RUs 106, such as the RU 106c. The SPS 114 may correspond to one or more of a Global Navigation Satellite System (GNSS), a global position system (GPS), a non-terrestrial network (NTN), or other satellite position/location system. The SPS 114 may be associated with LTE signals, NR signals (e.g., based on round trip time (RTT) and/or multi-RTT), wireless local area network (WLAN) signals, a terrestrial beacon system (TBS), sensor-based information, NR enhanced cell ID (NR E-CID) techniques, downlink angle-of-departure (DL-AoD), downlink time difference of arrival (DL-TDOA), uplink time difference of arrival (UL-TDOA), uplink angle-of-arrival (UL-AoA), and/or other systems, signals, or sensors.

Still referring to FIG. 1, in certain aspects, any of the UEs 102 may include a UE-based channel state information (CSI) processing component 140 configured to: receive, from a network entity, a configuration for a machine learning (ML)-based CSI report associated with a first channel state information-reference signal (CSI-RS); receive, from the network entity, the first CSI-RS; and transmit, to the network entity, the ML-based CSI report based on a UE capability for processing the ML-based CSI report in association with the first CSI-RS.

In certain aspects, any of the base stations 104 or a network entity of the base stations 104 may include a network-based CSI processing component 150 configured to: transmit, to a UE, a configuration for an ML-based CSI report associated with a first CSI-RS; transmit, to the UE, the first CSI-RS; and receive, from the UE, the ML-based CSI report including CSI that is based on a UE capability for processing the ML-based CSI report in association with the first CSI-RS.

Accordingly, FIG. 1 describes a wireless communication system that may be implemented in connection with aspects of one or more other figures described herein. Further, although the following description may be focused on 5G NR, the concepts described herein may be applicable to other similar areas, such as 5G-Advanced and future versions, LTE, LTE-advanced (LTE-A), and other wireless technologies, such as 6G.

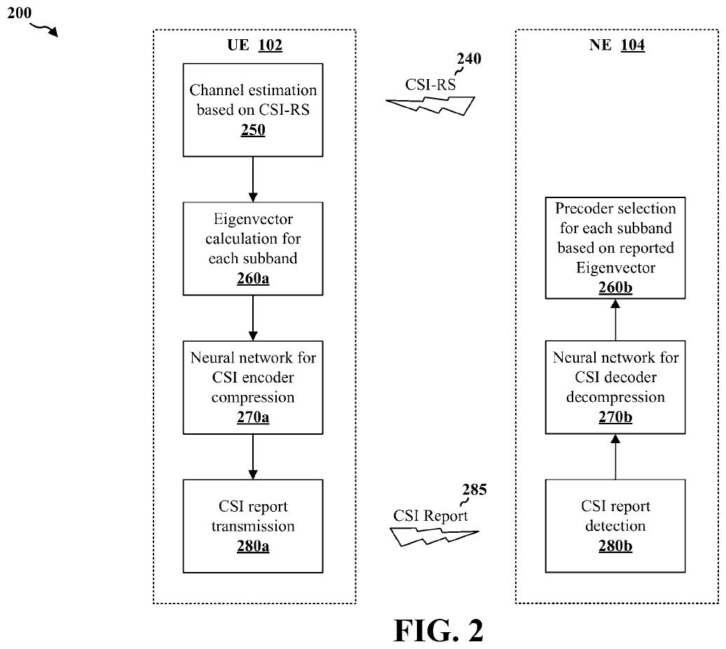

FIG. 2 illustrates a diagram 200 for example ML-based CSI encoder compression at a UE 102 and example ML-based CSI decoder decompression at a network entity 104. In a MIMO system, the network entity 104 may use CSI to select a digital precoder for a UE 102. The network entity 104 may configure a CSI report 285 through RRC signaling (e.g., CSI-reportConfig), where the UE 102 uses a channel measurement resource (CMR) to measure a CSI-RS 240 for estimating 250 a downlink channel. The network entity 104 may also configure (e.g., via the CSI-reportConfig), an interference measurement resource (IMR) for the UE 102 to measure interference. Based on the CMR and the IMR, the UE 102 is able to identify the CSI, which may include a rank indicator (RI), a precoding matrix indicator (PMI), a channel quality indicator (CQI), and/or a layer indicator (LI). The RI and the PMI are used to determine a digital precoder (also called a precoding matrix), the CQI indicates a signal-to-interference plus noise (SINR) for determining the transmitter's selection of a modulation and coding scheme (MCS). The LI is used to identify a strongest layer, such as for multi-user (MU)-MIMO pairing with low rank transmissions and the precoder selection for a phase-tracking reference signal (PT-RS).

The UE 102 may indicate the CSI report 285 in two parts via physical uplink control channel (PUCCH)/physical uplink shared channel (PUSCH), where CSI part 1 may include the RI and the CQI for a first transport block (TB), and CSI part 2 may include the PMI, the LI, and the CQI for a second TB. A payload size for CSI part 2 may be based on the CSI part 1, and both parts may be transmitted to the network entity 104 with separate channel coding operations.

The network entity 104 may configure a time-domain behavior (e.g., periodic, semi-persistent, or aperiodic report) for the CSI report 285 in the CSI-reportConfig. The network entity 104 can activate or deactivate a semi-persistent CSI report through a MAC-control element (MAC-CE). The network entity 104 can also trigger an aperiodic CSI report through downlink control information (DCI). The UE 102 may report the periodic CSI on a PUCCH resource configured in the CSI-reportConfig. The UE 102 may report the semi-persistent CSI on a PUCCH resource configured in the CSI-reportConfig or a PUSCH resource triggered by the DCI from the network entity 104. The UE 102 may report the aperiodic CSI on a PUSCH resource triggered by the DCI from the network entity 104.

ML is an example technique that the UE 102 may implement for performing the CSI compression 270a, where a first v columns of an Eigen vector for an average channel for each subband may be used as input. As used herein, unless otherwise specifically indicated, the terms “machine learning” and “artificial intelligence” may be used interchangeably with each other.

The diagram 200 illustrates an example for ML-based CSI compression after the UE 102 receives the CSI-RS 240 from the network entity 104. The UE 102 may perform channel estimation 250 based on the CSI-RS 240, and calculate 260a the Eigenvector for the channel in each subband. The Eigenvectors may be input to a neural network for CSI encoder compression 270a. The UE 102 transmits 280a the compressed CSI report 285 to the network entity 104.

The network entity 104 performs CSI report detection 280b of the CSI report transmission 280a from the UE 102. A neural network at the network entity 104 decodes the compressed CSI report 285 to recover the Eigenvector via CSI decoder decompression 270b. The network entity 104 selects 260b a precoder for each subband based on the reported Eigenvector.

ML-based CSI compression techniques may refer to the following terminology:

Data collection refers to a process of collecting data by the network nodes, the management entity, or the UE 102 for ML model training, data analytics, and inference.

ML model refers to a data-driven algorithm that applies ML techniques to generate a set of outputs based on a set of inputs.

ML model training refers to a process of training the ML model (e.g., by learning the input/output relationship) in a data-driven manner to obtain the trained ML model for inference.

ML model inference refers to a process of using the trained ML model to generate a set of outputs based on a set of inputs.

ML model validation refers to a sub-process of ML model training for evaluating a quality of the ML model using a dataset different from a training dataset used for model training. The different data may be used for selecting model parameters that generalize the data beyond the dataset used for the ML model training.

ML model testing refers to a sub-process of ML model training for evaluating the performance of the trained ML model using the dataset that is different from the training dataset for the ML model training and validation. Different from ML model validation, testing does not assume subsequent tuning of the ML model.

UE-side ML model refers to an ML model where inferencing is performed at the UE 102.

Network-side ML model refers to an ML model where inferencing is performed at the network/network entity 104.

One-sided ML model refers to a UE-side ML model or a network-side ML model.

Two-sided ML model refers to a paired ML model(s) over which joint inference is performed, where joint inference includes an ML inference that is performed jointly across the UE 102 and the network entity 104 (e.g., a first portion of inference is performed by the UE 102 and a remaining portion of the inference is performed by the network entity 104, or vice versa).

ML model transfer refers to delivery of an ML model over an air interface, based on either parameters of a model structure known at the receiving end or a new model with parameters. Delivery techniques may include transfer of a full ML model or a ML partial model.

Model download refers to ML model transfer from the network entity 104 to the UE 102.

Model upload refers to ML model transfer from the UE 102 to the network entity 104.

Federated learning/federated training refers to a machine learning technique that trains an ML model across multiple decentralized edge nodes (e.g., UEs, network entities, etc.) that each perform local model training using local data samples. Federated learning/training may be based on multiple interactions with the ML model, but without exchanging local data samples.

Offline field data refers to the data collected from the field and used for offline training of the ML model.

Online field data refers to the data collected from the field and used for online training of the ML model.

Model monitoring refers to a procedure for monitoring the inference performance of the ML model.

Supervised learning refers to a process of training a model from inputs and corresponding labels.

Unsupervised learning refers to a process of training a model without labelled data.

Semi-supervised learning refers to a process of training a model based on a mix of labelled data and unlabelled data.

Reinforcement learning (RL) refers to a process of training an ML model from input (a.k.a. state) and a feedback signal (a.k.a. reward) resulting from the model's output (a.k.a. action) in an environment with which the model interacts.

Model activation refers to enabling an ML model for a specific function.

Model deactivation refers to disabling an ML model for a specific function.

Model switching refers to deactivating a currently active ML model and activating a different ML model for a specific function.

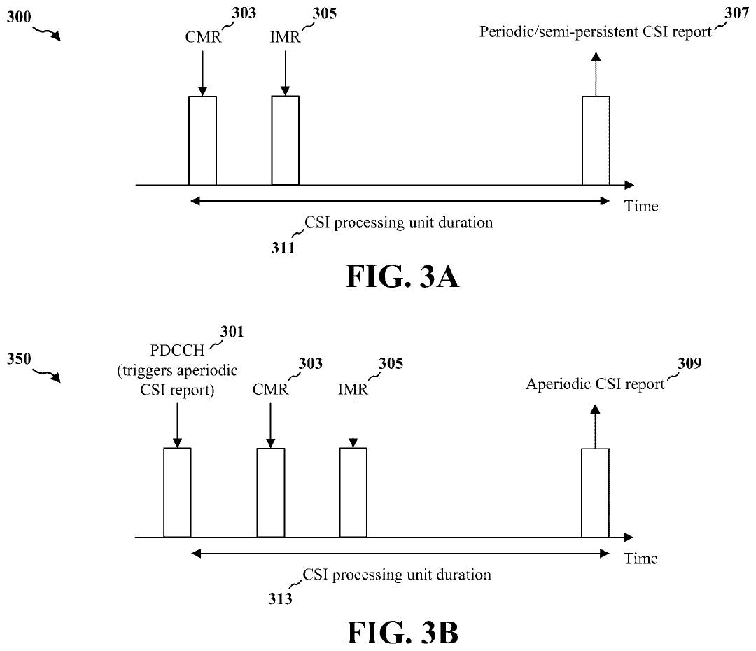

FIG. 3A illustrates a first timing diagram 300 for a first CSI processing unit (CPU) duration 311 associated with periodic/semi-persistent CSI reporting. FIG. 3B illustrates a second timing diagram 350 for a second CPU duration 313 associated with aperiodic CSI reporting. The UE 102 can be configured with multiple CSI-reportConfig information elements (IEs) for multiple CSI measurements and reports. Thus, a plurality of CPUs may be used for parallel processing of received CSI-RS to create a plurality of CSI measurements and reports. The UE 102 may transmit UE capability information to the network entity 104 indicating a number of CPUs that the UE 102 supports. If the network entity 104 requests CSI reports that have more parallel CSI processing at the UE 102 than the number of CPUs available at the UE 102 (i.e., indicated in the UE capability report), the UE 102 can report non-current information for low priority CSI reports. In some examples, the UE 102 may determine a priority of a particular CSI report based on predefined protocols. For example, a CPU occupancy rule for the periodic/semi-persistent CSI report 307 and the aperiodic CSI report 309 may be based on the predefined protocols.

The first CPU duration 311 for the periodic/semi-persistent CSI report 307 corresponds to a CPU with an occupancy that begins at a first symbol of earliest resources for the CMR 303 or the IMR 305 used for measurements by the UE 102. For example, the UE 102 may perform one or more of CSI-RS measurements, CSI-interference measurements (CSI-IMs), synchronization signal block (SSB) measurements, etc. The first CPU duration 311 for the periodic/semi-persistent CSI report 307 continues through last resources for the CMR 303 and the IMR 305 used for the measurement of the UE 102 and ends at a last symbol of a PUSCH/PUCCH used by the UE 102 for transmitting the periodic/semi-persistent CSI report 307 to the network entity 104.

The second CPU duration 313 for the aperiodic CSI report 309 corresponds to a CPU with an occupancy that begins at a first symbol after receiving a physical downlink control channel (PDCCH) 301 that triggers the aperiodic CSI report 309. The second CPU duration 313 for the aperiodic CSI report 309 continues through last resources for the CMR 303 and the IMR 305 used for the measurement of the UE 102 and ends at a last symbol of a PUSCH used by the UE 102 for transmitting the aperiodic CSI report 309 to the network entity 104. If the PDCCH 301 that triggers the aperiodic CSI report 309 corresponds to two PDCCH candidates from two respective search space sets, the PDCCH candidate that ends later in time is used for determining the second CPU duration 313 for the aperiodic CSI report 309.

If the PDCCH 301 triggers an initial semi-persistent CSI report on the PUSCH, the CPU duration for the initial semi-persistent CSI report may not be the same as the first CPU duration 311 for the periodic/semi-persistent CSI report 307. Instead, the CPU duration for the initial semi-persistent CSI report may correspond to the second CPU duration 313 for the aperiodic CSI report 309. That is, the CPU duration for the initial semi-persistent CSI report transmitted on the PUSCH, after the PDCCH 301, begins at the first symbol after the PDCCH 301 and ends at the last symbol of the PUSCH that carries the initial semi-persistent CSI report. If the PDCCH 301 that triggers the initial semi-persistent CSI report corresponds to two PDCCH candidates from two respective search space sets, the PDCCH candidate that ends later in time is used for determining the CPU duration for the initial semi-persistent CSI report.

CSI reporting by the UE 102 may be based on a minimum processing delay time. For example, scheduling for the periodic/semi-persistent CSI report 307 or the aperiodic CSI report 309 may include minimum processing delays of Z and Z′. Values of Z and Z′ for different types of CSI reports may be based on one or more predefined protocols. If a scheduling offset does not indicate the minimum processing delays of Z and Z′, the UE 102 can report the minimum processing delay associated with the non-current CSI or disregard a triggering DCI, if no other signals (e.g., data or hybrid automatic repeat request (HARQ)-acknowledgment (ACK) (HARQ-ACK)) are to be transmitted on the PUSCH triggered by the DCI (e.g., PDCCH 301). If a CSI request field of the DCI is used to trigger one or more CSI reports from the UE 102 on the PUSCH, the UE 102 may transmit the one or more CSI reports to the network entity 104, if the first uplink symbol associated with the one or more CSI reports serves as a timing advance that starts no earlier than symbol Z_{ref}. For instance, the UE 102 may transmit an n-th triggered CSI report to the network entity 104, if the first uplink symbol associated with the n-th CSI report starts no earlier than symbol Z′_{ref}(n).

The ML-based CSI report may be implemented by the UE 102 based on different hardware (e.g., a neural processing unit (NPU)) compared to non-ML-based CSI reports. A CPU may not be shared for ML-based and non-ML-based CSI reports. Thus, techniques may be implemented to manage the parallel processing of multiple ML-based CSI reports as well as mixed ML-based/non-ML-based CSI reports. Moreover, the complexity of ML-based CSI reports may be based on the ML model, which may be associated with a minimum processing delay for ML-based CSI reports. Hence, a method is proposed for the parallel processing for ML-based CSI measurements and reports based on a CPU management framework and the minimum processing delay.

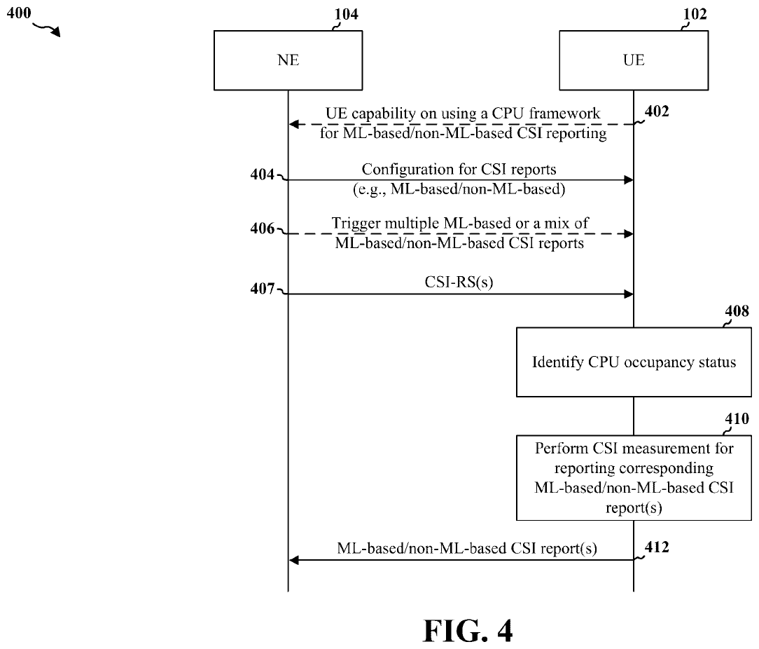

FIG. 4 is a signaling diagram 400 illustrating an ML-based CSI report processing procedure. In some examples, the ML-based CSI report processing procedure may be implemented via different hardware than a non-ML-based CSI report processing procedure (e.g., via the NPU). The NPU may be dedicated to the ML-based CSI report processing procedure or shared with other applications (e.g., a non-wireless communication-based application). In other examples, the ML-based CSI report processing procedure may be implemented via the same hardware as used for the non-ML-based CSI report processing procedure. Thus, a second CPU framework may be introduced for the ML-based CSI report processing procedure. A Type 2 CPU, as used herein, refers to a CPU that is used for the ML-based CSI report processing procedure, but is not shared with/used for the non-ML-based CSI report processing procedure. Shared CPUs with the non-ML-based CSI report processing procedure may be referred to as Type 1 CPUs.

The UE 102 transmits 402, to the network entity 104, a UE capability report on using a CPU framework for ML-based/non-ML-based CSI reporting. The UE capability report can further indicate whether the UE 102 supports ML-based CSI compression, a maximum number of Type 2 CPUs that the UE 102 supports, etc. The network entity 104 may transmit 404, to the UE 102, a configuration for the CSI framework associated with multiple CSI reports. For example, the network entity 104 may transmit 404 the configuration for a CSI report by RRC signaling (e.g., CSI-reportConfig). For semi-persistent and aperiodic CSI reports, the network entity 104 may transmit 406, to the UE 102, a triggering indication, such as a MAC-CE or a DCI that triggers a corresponding CSI report. The triggering indication may trigger, from the UE 102, multiple ML-based CSI reports or a mix of ML-based/non-ML-based CSI reports. The network entity 104 may use the MAC-CE to activate a semi-persistent CSI report and the DCI to trigger an aperiodic CSI report.

After receiving 406 the control signaling to trigger the CSI report(s), the UE 102 receives 407 one or more CSI-RS(s) from the network entity 104. The UE 102 may identify 408 a CPU occupancy status. For example, the UE 102 determines, according to a priority of the ML-based/non-ML-based CSI reports(s), which ML-based/non-ML-based CSI report(s) the UE 102 can transmit 412 to the network entity 104 based on updated CSI measurement(s). The UE 102 performs 410 the updated CSI measurement(s) for reporting high priority ML-based/non-ML-based CSI report(s) to the network entity 104, but may use a previous (e.g., outdated) CSI measurement for reporting low priority ML-based/non-ML-based CSI report(s) to the network entity 104. The UE 102 includes the updated CSI in the transmitted 412 CSI report(s) for the high priority CSI report(s) and the previously measured CSI in the transmitted 412 CSI report(s) for the low priority CSI report(s), such as in cases where the number of Type 1 CPUs or Type 2 CPUs exceeds the maximum number of Type 1 CPUs or the maximum number of Type 2 CPUs associated with the UE capability.

The UE capability report indicates at least one UE capability, such as whether the UE 102 supports ML-based CSI report processing, whether the ML-based CSI report processing can share a same CPU as used for non-ML-based CSI report processing, a maximum number of Type 2 CPUs per component carrier (CC), per band, per band combination, or per UE, etc. The UE 102 may report 402 UE capability information for Type 2 CPU in addition to a UE capability for a maximum number of Type 1 CPUs (e.g., simultaneousCSI-ReportsPerCC for the number of Type 1 CPUs per CC, and simultaneousCSI-ReportsAllCC for the number of Type 1 CPUs across all CCs). In examples, if the UE 102 supports ML-based CSI processing with zero Type 2 CPUs, the network entity 104 may assume that the ML-based CSI report processing can share the same CPU as used for the non-ML-based CSI report processing. In addition, if the NPU used for the ML-based CSI report processing can be shared with other applications, the UE 102 may report an on/off duration for the Type 2 CPU. When a Type 2 CPU is “off”, the CPU may not be counted for ML-based CSI report processing. The on/off duration may be reported based on a maximum periodicity and “on” duration for the Type 2 CPU.

The network entity 104 may configure whether the ML-based CSI report can occupy Type 2 CPU(s). The ML-based CSI report can also occupy Type 1 CPU(s) when the ML-based CSI report does not occupy the Type 2 CPU(s). The network entity 104 may provide a CPU type indication to the UE 102 for the CSI report(s) via RRC signaling (e.g., an RRC parameter in the CSI-reportConfig). The network entity 104 may provide the CPU type indication for the CSI report(s) by MAC-CE. In examples, the network entity 104 may provide the CPU type indication by MAC-CE for semi-persistent CSI reports. In other examples, the network entity 104 may provide the CPU type indication based on separate MAC-CEs, where the MAC-CEs indicate at least one of a serving cell index, a bandwidth part (BWP) index, CSI-reportConfig ID(s), or a CPU type indication for the indicated CSI-reportConfig.

The network entity 104 may similarly provide the CPU type indication to the UE 102 for the CSI report(s) via DCI. In examples associated with aperiodic CSI reports, the network entity 104 may indicate the CPU type by the DCI used to trigger the CSI report. A field may be included in the DCI that indicates the CPU type. Alternatively, the network entity 104 may configure the CPU type corresponding to a CSI trigger state and, based on indicating different values for the CSI request field in the DCI, the network entity 104 may indicate the corresponding CPU type.

If the UE 102 reports ML-based CSI processing capabilities for Type 2 CPUs, a Type 2 CPU may be occupied based on similar rules/protocols as used for Type 1 CPUs. For example, similar to FIG. 3A, a periodic or semi-persistent CSI report (e.g., excluding an initial semi-persistent CSI report on PUSCH after a PDCCH that triggers the CSI report) may occupy Type 2 CPU(s) from a first symbol of an earliest one of a CSI-RS resource, a CSI-IM resource, or an SSB resource for a channel measurement or interference measurement, where latest CSI-RS/CSI-IM/SSB occasions are no later than the corresponding CSI reference resource. The Type 2 CPU may continue until a last symbol of the configured PUSCH/PUCCH carrying the CSI report. Similar to FIG. 3B, an aperiodic CSI report may occupy Type 2 CPU(s) from the first symbol after the PDCCH triggering the CSI report until the last symbol of the scheduled PUSCH carrying the CSI report. When the PDCCH reception includes two PDCCH candidates from two separate search space sets, the PDCCH candidate that ends later in time is used for determining the CPU occupancy duration.

An initial semi-persistent CSI report on PUSCH after the PDCCH that triggers the CSI report may occupy Type 2 CPU(s) from the first symbol after the PDCCH until the last symbol of the scheduled PUSCH carrying the CSI report. When the PDCCH reception includes two PDCCH candidates from two separate search space sets, the PDCCH candidate that ends later in time is used for determining the CPU occupation duration. That is, the network entity 104 and the UE 102 may consider Type 2 CPU(s) as a subset of Type 1 CPU(s). Thus, if a Type 2 CPU is occupied, a Type 1 CPU is considered to be occupied. Hence, the maximum number of Type 2 CPU(s) reported in the UE capability report is less than or equal to the maximum number of Type 1 CPU(s) reported in the UE capability report.

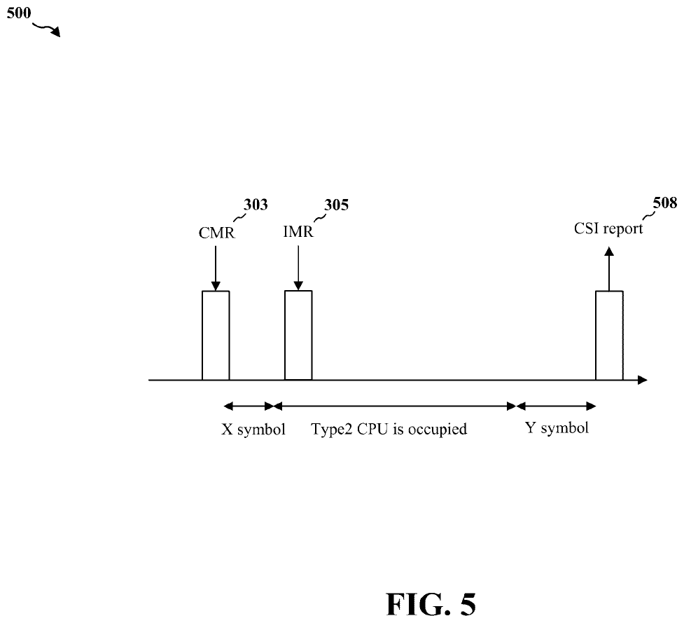

FIG. 5 illustrates a timing diagram 500 for Type 2 CPU occupancy. The UE 102 may utilize the NPU after the channel is indicated to the UE 102. Hence, the UE 102 may assume that the Type 2 CPU is occupied after X symbols from the first/last symbol of the earliest/latest CMR 303 or IMR 305, until Y symbols before the first/last symbol of PUSCH/PUCCH used for the CSI report 508. The values of X and Y may be predefined or reported via a UE capability message. FIG. 5 illustrates an example for the Type 2 CPU occupancy rule/protocol described above.

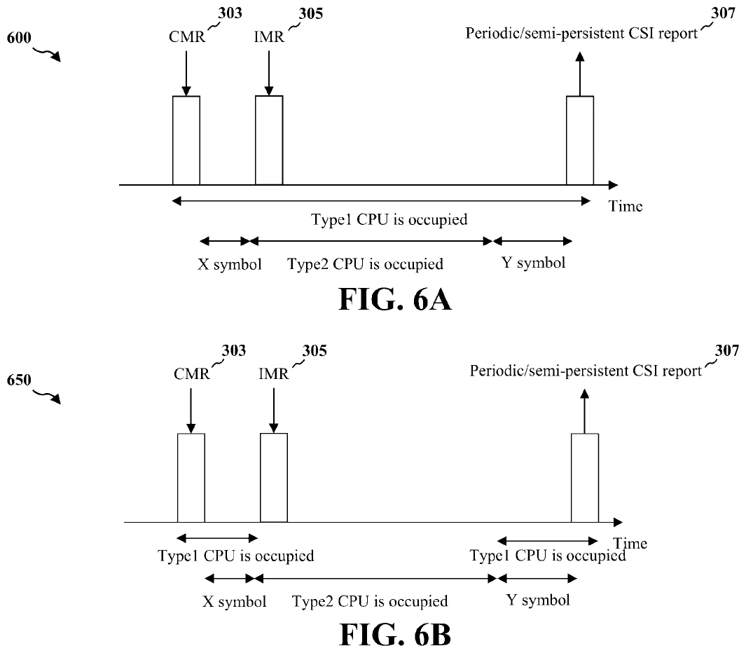

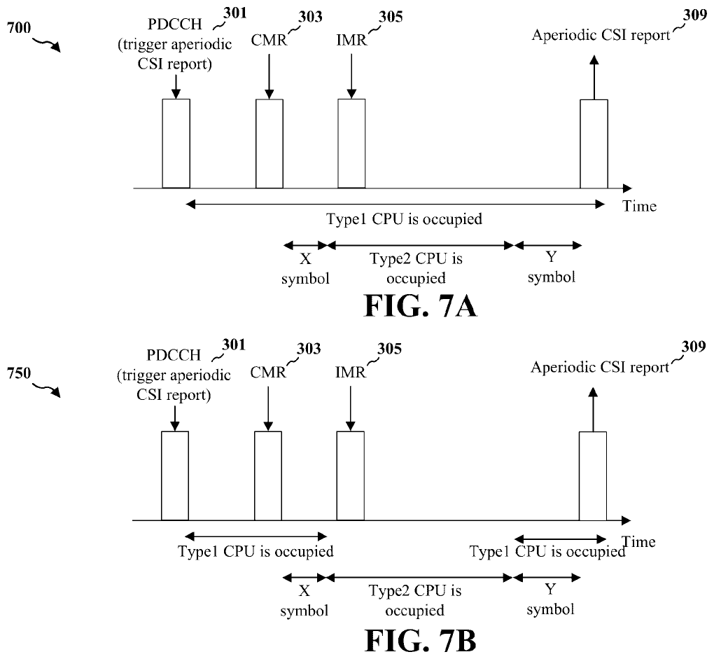

FIGS. 6A-6B illustrate example timing diagrams 600-650 of CPU occupancy for an ML-based periodic/semi-persistent CSI report 307. FIGS. 7A-7B illustrate example timing diagrams 700-750 of CPU occupancy for an ML-based aperiodic CSI report 309. If the UE 102 supports ML-based CSI processing for Type 2 CPUs, the ML-based CSI report processing may utilize Type 1 CPUs as well, since other CSI processing procedures (e.g., decoding CSI-RS, RI, and CQI calculation) may be performed without neural network processing.

In examples, both Type 1 CPUs and Type 2 CPUs may be occupied based on the same rules/protocols as used for Type 1 CPU occupancy. In other examples, the network entity 104 and the UE 102 may determine that Type 1 CPU occupancy is based on legacy protocols and Type 2 CPU is occupancy occurs after X symbols from the first/last symbol of the earliest/latest one of the CMR 303 or the IMR 305, until Y symbols before the first/last symbol of PUSCH/PUCCH used for the CSI report 307, 309. The values of X and Y may be predefined or reported via the UE capability message.

In some implementations, the network entity 104 and the UE 102 may determine that a Type 1 CPU is occupied based on a legacy protocol, excluding the duration when a Type 2 CPU is occupied, as illustrated in the diagrams 650, 750. For example, the Type 1 CPU may begin after a PDCCH 301 that triggers an aperiodic CSI report 309 or, for periodic/semi-persistent CSI reports 307, after the first/last symbol of the earliest/latest one of the CMR 303 or the IMR 305, but may be excluded during the Type 2 CPU occupancy duration. The Type 2 CPU in the diagrams 650, 750 may be occupied, as described above, after X symbols from the first/last symbol of the earliest/latest one of the CMR 303 or the IMR 305, until Y symbols before the first/last symbol of PUSCH/PUCCH used for the CSI report 307, 309. Likewise, the values of X and Y may be predefined or reported via the UE capability message. In other examples, the network entity 104 and the UE 102 may determine that a Type 1 CPU is occupied based on the legacy protocol, inclusive of the duration when a Type 2 CPU is occupied, as illustrated in the diagrams 600, 700.

If ML-based CSI report processing is based on Type 2 CPUs, after determining/identifying the Type 2 CPU occupancy status, the UE 102 may process N_{CPU,2} ML-based CSI reports of high priority, where N_{CPU,2} corresponds to the maximum number of Type 2 CPUs that the UE reports in the UE capability report. For other (low) priority CSI reports, the UE 102 may report previously measured (e.g., outdated) CSI to the network entity 104.

If ML-based CSI report processing is based on both Type 1 CPUs and Type 2 CPUs, after determining/identifying the Type 1 and Type 2 CPU occupancy statuses, the UE 102 may process the min{N_{CPU,1}-n_{CPU,1}, N_{CPU,2}} ML-based CSI reports of higher priority, where N_{CPU,1} corresponds to the maximum number of Type 1 CPUs that the UE 102 reports in the UE capability report and n_{CPU,1} corresponds to the number of CPUs used by other high priority non-ML-based CSI reports. For other (low) priority CSI report(s), the UE 102 may report previously measured (e.g., outdated) CSI to the network entity 104. In other examples, the network entity 104 may refrain from configuring or triggering CSI reports that utilize more Type 1 and Type 2 CPUs than the maximum number of Type 1 and Type 2 CPUs reported by the UE 102 in the UE capability report.

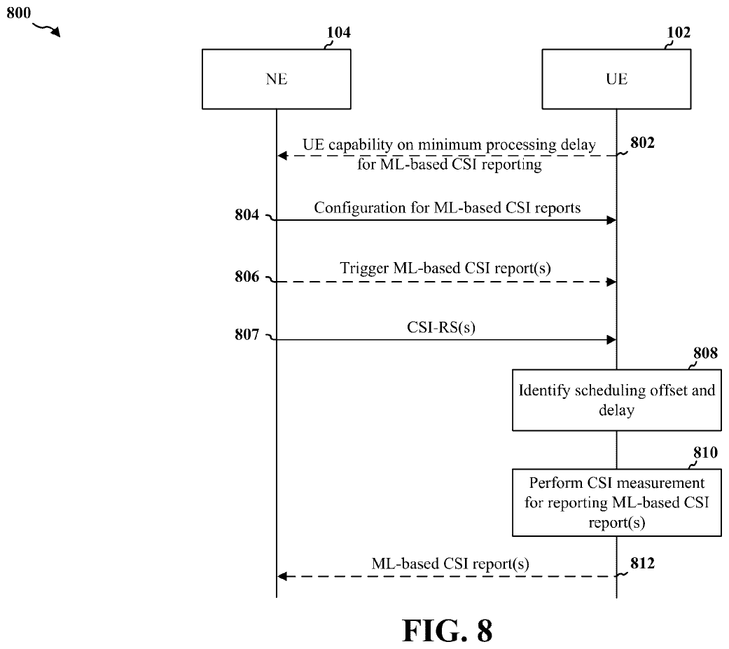

FIG. 8 illustrates a signaling diagram 800 for CSI reporting based on a minimum processing delay. The minimum processing delay for an ML-based CSI report may depend on whether the UE 102 uses dedicated hardware for processing the ML-based CSI report. Dedicated hardware, such as an NPU, may increase a neural network processing speed beyond a processing speed associated with other hardware. The minimum processing delay may also depend on the neural network architecture. If the network entity 104 schedules a smaller scheduling offset than the minimum processing delay, the UE 102 may determine to report previously measured (e.g., outdated) CSI to the network entity 104 or disregard the DCI if no HARQ-ACK or data is to be transmitted on the PUSCH triggered by the DCI.

The UE 102 transmits 802, to the network entity 104, a UE capability report indicating a UE capability on the minimum processing delay for ML-based CSI reporting. The network entity 104 transmits 804 a configuration for a CSI framework associated with ML-based CSI reporting. The network entity 104 may transmit 804 the configuration for the ML-based CSI reports via RRC signaling (e.g., via a CSI-reportConfig). For semi-persistent and aperiodic CSI reports, the network entity 104 may transmit 806 a MAC-CE or DCI that triggers the corresponding ML-based CSI reports. The network entity 104 may transmit 806 the MAC-CE to activate a semi-persistent CSI report or the DCI to trigger an aperiodic CSI report.

After receiving 806 the control signaling to trigger the CSI report(s), the UE 102 receives 807 one or more CSI-RS(s) from the network entity 104. The UE 102 determines/identifies 808 a scheduling offset and delay to perform 810 the CSI measurement for reporting the ML-based CSI report(s). For example, the UE 102 may determine whether to perform ML-based CSI report processing based on the processing time for the ML-based CSI report in comparison to the scheduling offset. If the scheduling offset satisfies the minimal processing delay for ML-based CSI report processing, the UE 102 transmits 812 the ML-based CSI report(s) to the network entity 104.

The UE 102 may report the minimum processing delay Z and Z′ for CSI reports, where Z and Z′ may indicate when the CSI request field of the DCI triggers the ML-based CSI report(s) on PUSCH, such that the UE 102 may transmit 812 the ML-based CSI report for the n-th triggered report, if the first uplink symbol to carry the corresponding ML-based CSI reports based on the timing advance starts no earlier than symbol Z and if the first uplink symbol to carry the n-th ML-based CSI report based on the timing advance starts no earlier than symbol Z′. The network entity 104 and the UE 102 may determine the minimum processing delay Z and Z′ based on whether the UE 102 uses a Type 2 CPU for the ML-based CSI report(s). In examples, two sets of Z and Z′ may be predefined, where the first set is applied when the UE 102 does not use the Type 2 CPU and the second set is applied when the UE 102 does use the Type 2 CPU for the ML-based CSI report(s).

Since the minimum processing delay depends on the ML model, the UE 102 may report the supported Z and Z′ values for each ML model that the UE 102 supports. The UE 102 may report more than one ML model that the UE 102 supports. The network entity 104 may indicate the ML model to be used for the ML-based CSI report processing via higher layer signaling (e.g., RRC signaling in the CSI-reportConfig). The UE 102 applies the corresponding minimum processing delay for the ML-based CSI report processing at the UE 102.

The UE 102 may not be able to perform parallel processing of ML-based CSI reports due to limitations of dedicated hardware for the ML-based CSI reports. Hence, the minimum processing delay may be based on the number of ML-based CSI reports for CSI reporting at a same time. The minimum processing delay Z and Z′ for a single ML-based CSI report may be predefined or reported by the UE 102 via the UE capability message. For N ML-based CSI reports, the minimum processing delay may be μNZ and μNZ′, where μ may be predefined, configured by higher layer signaling from the network entity 104 (e.g., RRC signaling in the CSI-reportConfig), or reported in the UE capability message based on a range of (0, 1). The UE 102 may also report whether the UE 102 supports parallel processing as a second UE capability.

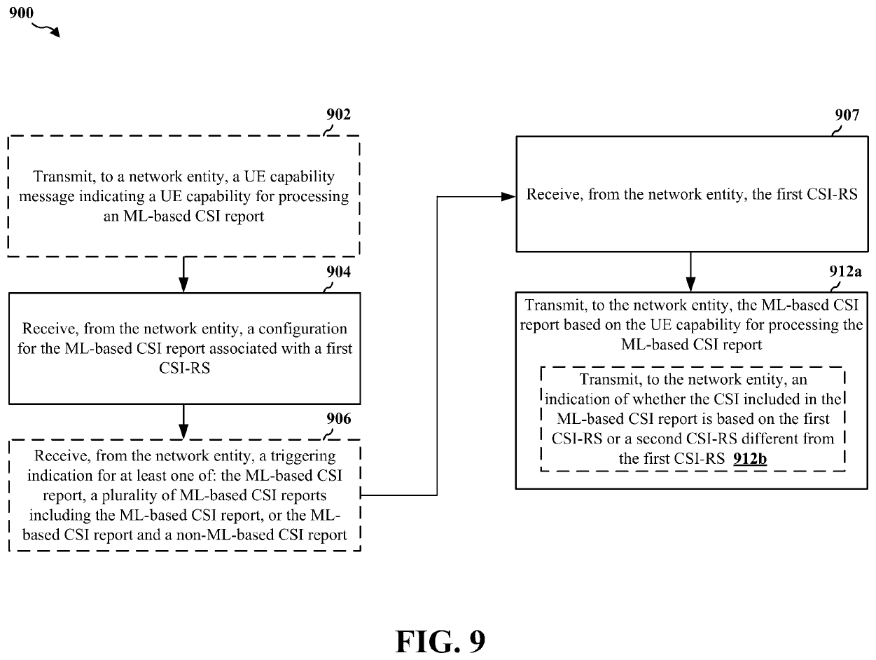

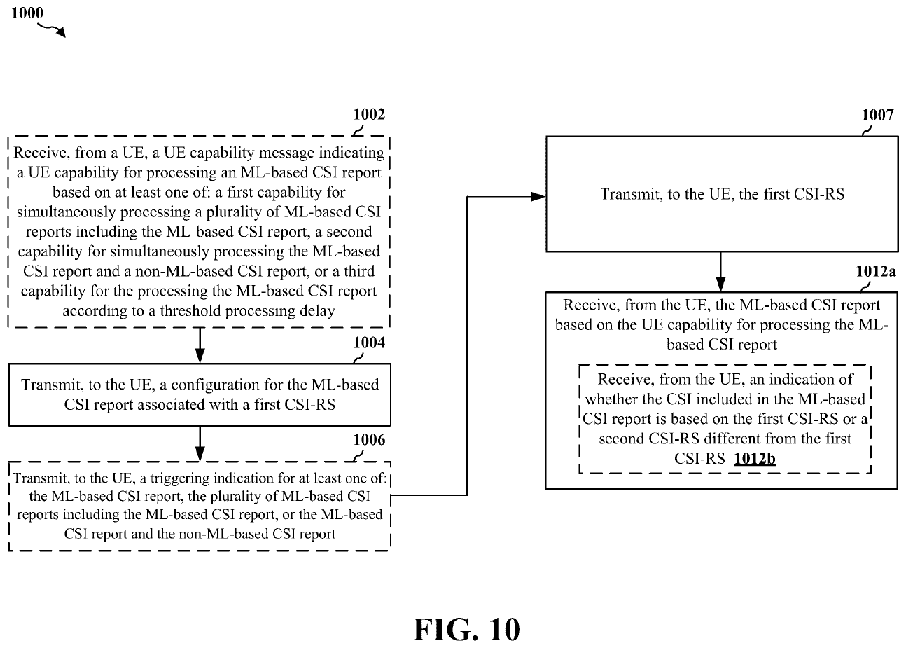

For triggered ML-based CSI report(s), if the scheduling offset does not satisfy the minimum processing delay Z or Z′, the UE 102 may disregard the DCI if no HARQ-ACK or data is transmitted on the PUSCH scheduled by the DCI. If the scheduling offset does not satisfy the minimum processing delay Z or Z′, the UE 102 may report previously measured (e.g., outdated) CSI for all of the triggered CSI report(s), or the UE 102 may report the previously measured (e.g., outdated) CSI for the triggered CSI report(s) that do not satisfy the minimum processing delay Z or Z′. The network entity 104 may refrain from configuring or triggering ML-based CSI reports with smaller scheduling offsets than the minimum processing delay for the ML-based CSI report. FIGS. 9-10 show methods for implementing one or more aspects of FIGS. 1-8. In particular, FIG. 9 shows an implementation by the UE 102 of the one or more aspects of FIGS. 1-8. FIG. 10 shows an implementation by the network entity 104 of the one or more aspects of FIGS. 1-8.

FIG. 9 illustrates a flowchart 900 of a method of wireless communication at a UE. With reference to FIGS. 1-2, 4, 8, and 11, the method may be performed by the UE 102, the UE apparatus 1102, etc., which may include the memory 1126′, 1106′, 1116, and which may correspond to the entire UE 102 or the entire UE apparatus 1102, or a component of the UE 102 or the UE apparatus 1102, such as the wireless baseband processor 1126 and/or the application processor 1106.

The UE 102 transmits 902, to a network entity, a UE capability message indicating a UE capability for processing an ML-based CSI report. For example, referring to FIG. 4, the UE 102 transmits 402, to the network entity 104, a UE capability message on using a CPU framework for ML-based/non-ML-based CSI reporting. Referring to FIG. 8, the UE 102 transmits 802, to the network entity 104, a UE capability message on a minimum processing delay for ML-based CSI reporting.

The UE 102 receives 904, from the network entity, a configuration for the ML-based CSI report associated with a first CSI-RS. For example, referring to FIG. 4, the UE 102 receives 404, from the network entity 104, a configuration for CSI reports (e.g., ML-based/non-ML-based CSI reports) associated with the CSI-RS(s) 407. Referring to FIG. 8, the UE 102 receives 804, from the network entity 104, a configuration for ML-based CSI reports associated with the CSI-RS(s) 807.

The UE 102 receives 906, from the network entity, a triggering indication for at least one of: the ML-based CSI report, a plurality of ML-based CSI reports including the ML-based CSI report, or the ML-based CSI report and a non-ML-based CSI report. For example, referring to FIG. 4, the UE 102 receives 406, from the network entity 104, a trigger for multiple ML-based CSI reports or a mix of ML-based/non-ML-based CSI reports. Referring to FIG. 8, the UE 102 receives 806, from the network entity 104, a trigger for ML-based CSI report(s).

The UE 102 receives 907, from the network entity, the first CSI-RS. For example, referring to FIG. 4, the UE 102 receives 407, from the network entity 104, CSI-RS(s), such that the UE 102 may identify 408 a CPU occupancy status and perform 410 a CSI measurement for reporting corresponding ML-based/non-ML-based CSI report(s). Referring to FIG. 8, the UE 102 receives 807, from the network entity 104, CSI-RS(s), such that the UE 102 may identify 808 a scheduling offset and delay and perform 810 a CSI measurement for reporting ML-based CSI report(s).

The UE 102 transmits 912a, to the network entity, the ML-based CSI report based on the UE capability for processing the ML-based CSI report. For example, referring to FIG. 4, the UE 102 transmits 412, to the network entity 104, ML-based/non-ML-based CSI report(s) based on the CPU occupancy status. Referring to FIG. 8, the UE 102 transmits 812, to the network entity 104, ML-based CSI report(s) based on the scheduling offset and delay.

Transmission 912a of the ML-based CSI report can further include the UE 102 transmitting 912b, to the network entity 104, an indication of whether the CSI included in the ML-based CSI report is based on the first CSI-RS or a second CSI-RS different from the first CSI-RS. For example, referring to FIG. 4, the UE 102 can either transmit 412, to the network entity 104, the ML-based/non-ML-based CSI report(s) based on performing 410 the CSI measurement of the CSI-RS(s) 407 or based on a previous CSI measurement of previous CSI-RS(s) to the CSI-RS(s) 407. Referring to FIG. 8, the UE 102 can either transmit 812, to the network entity 104, the ML-based CSI report(s) based on performing 810 the CSI measurement of the CSI-RS(s) 807 or based on a previous CSI measurement of previous CSI-RS(s) to the CSI-RS(s) 807. FIG. 9 describes a method from a UE-side of a wireless communication link, whereas FIG. 10 describes a method from a network-side of the wireless communication link.

FIG. 10 is a flowchart 1000 of a method of wireless communication at a network entity. With reference to FIGS. 1-2, 4, 8, and 12, the method may be performed by one or more network entities 104, which may correspond to a base station or a unit of the base station, such as the RU 106, the DU 108, the CU 110, an RU processor 1206, a DU processor 1226, a CU processor 1246, etc. The one or more network entities 104 may include memory 1206′/1226′/1246′, which may correspond to an entirety of the one or more network entities 104, or a component of the one or more network entities 104, such as the RU processor 1206, the DU processor 1226, or the CU processor 1246.

The network entity 104 receives 1002, from a UE, a UE capability message indicating a UE capability for processing an ML-based CSI report based on at least one of: a first capability for simultaneously processing a plurality of ML-based CSI reports including the ML-based CSI report, a second capability for simultaneously processing the ML-based CSI report and a non-ML-based CSI report, or a third capability for the processing the ML-based CSI report according to a threshold processing delay. For example, referring to FIG. 4, the network entity 104 receives 402, from the UE 102, a UE capability message on using a CPU framework for ML-based/non-ML-based CSI reporting. Referring to FIG. 8, the network entity 104 receives 802, from the UE 102, a UE capability message on a minimum processing delay for ML-based CSI reporting.

The network entity 104 transmits 1004, to the UE, a configuration for the ML-based CSI report associated with a first CSI-RS. For example, referring to FIG. 4, the network entity 104 transmits 404, to the UE 102, a configuration for CSI reports (e.g., ML-based/non-ML-based CSI reports) associated with the CSI-RS(s) 407. Referring to FIG. 8, the network entity 104 transmits 804, to the UE 102, a configuration for ML-based CSI reports associated with the CSI-RS(s) 807.

The network entity 104 transmits 1006, to the UE, a triggering indication for at least one of: the ML-based CSI report, the plurality of ML-based CSI reports including the ML-based CSI report, or the ML-based CSI report and the non-ML-based CSI report. For example, referring to FIG. 4, the network entity 104 transmits 406, to the UE 102, a trigger for multiple ML-based CSI reports or a mix of ML-based/non-ML-based CSI reports. Referring to FIG. 8, the network entity 104 transmits 806, to the UE 102, a trigger for ML-based CSI report(s).

The network entity 104 transmits 1007, to the UE, the first CSI-RS. For example, referring to FIG. 4, the network entity 104 transmits 407, to the UE 102, CSI-RS(s), such that the UE 102 may identify 408 a CPU occupancy status and perform 410 a CSI measurement for reporting corresponding ML-based/non-ML-based CSI report(s). Referring to FIG. 8, the network entity 104 transmits 807, to the UE 102, CSI-RS(s), such that the UE 102 may identify 808 a scheduling offset and delay and perform 810 a CSI measurement for reporting ML-based CSI report(s).

The network entity 104 receives 1012a, from the UE, the ML-based CSI report based on the UE capability for processing the ML-based CSI report. For example, referring to FIG. 4, the network entity 104 receives 412, from the UE 102, ML-based/non-ML-based CSI report(s) based on the CPU occupancy status. Referring to FIG. 8, the network entity 104 receives 812, from the UE 102, ML-based CSI report(s) based on the scheduling offset and delay.

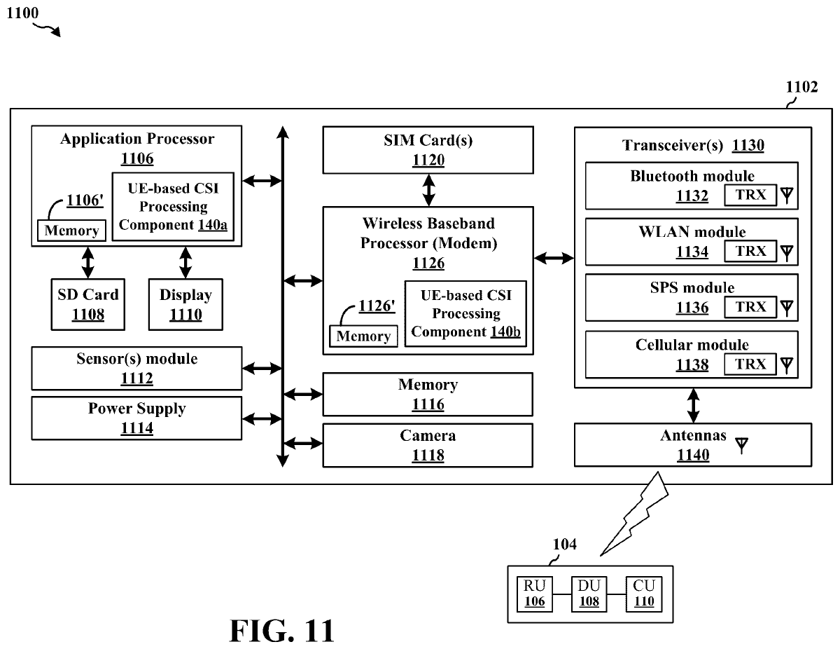

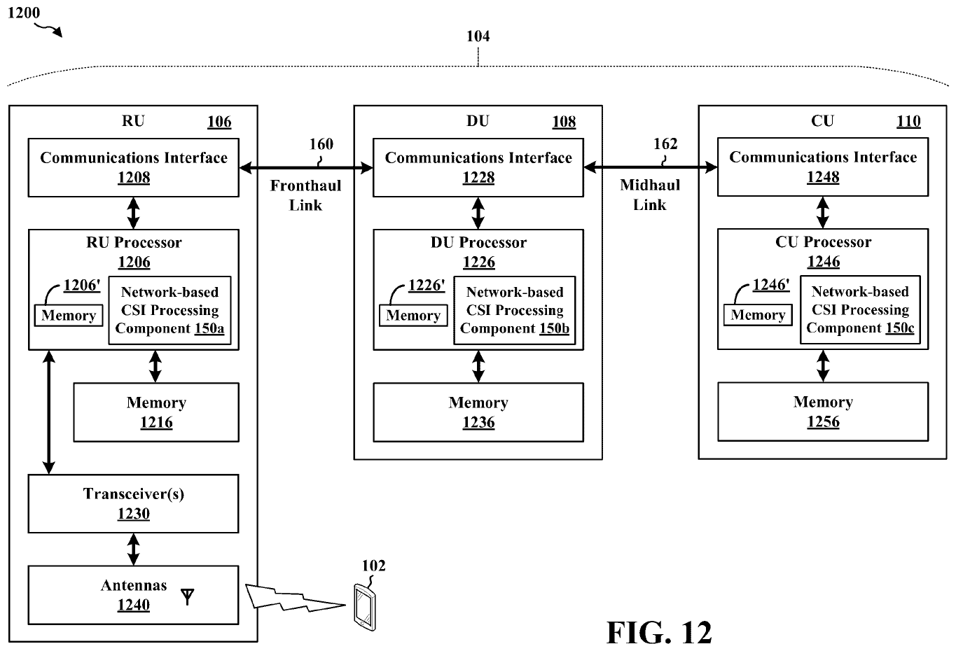

Reception 1012a of the ML-based CSI report can further include the network entity 104 receiving 1012b, from the UE 102, an indication of whether the CSI included in the ML-based CSI report is based on the first CSI-RS or a second CSI-RS different from the first CSI-RS. For example, referring to FIG. 4, the network entity 104 can either receive 412, from the UE 102, the ML-based/non-ML-based CSI report(s) based on the UE 102 performing 410 the CSI measurement of the CSI-RS(s) 407 or based on a previous CSI measurement by the UE 102 of previous CSI-RS(s) to the CSI-RS(s) 407. Referring to FIG. 8, the network entity 104 can either receive 812, from the UE 102, the ML-based CSI report(s) based on the UE 102 performing 810 the CSI measurement of the CSI-RS(s) 807 or based on a previous CSI measurement by the UE 102 of previous CSI-RS(s) to the CSI-RS(s) 807. A UE apparatus 1102, as described in FIG. 11, may perform the method of flowchart 900. The one or more network entities 104, as described in FIG. 12, may perform the method of flowchart 1000.

FIG. 11 is a diagram 1100 illustrating an example of a hardware implementation for a UE apparatus 1102. The UE apparatus 1102 may be the UE 102, a component of the UE 102, or may implement UE functionality. The UE apparatus 1102 may include an application processor 1106, which may have on-chip memory 1106′. In examples, the application processor 1106 may be coupled to a secure digital (SD) card 1108 and/or a display 1110. The application processor 1106 may also be coupled to a sensor(s) module 1112, a power supply 1114, an additional module of memory 1116, a camera 1118, and/or other related components. For example, the sensor(s) module 1112 may control a barometric pressure sensor/altimeter, a motion sensor such as an inertial management unit (IMU), a gyroscope, accelerometer(s), a light detection and ranging (LIDAR) device, a radio-assisted detection and ranging (RADAR) device, a sound navigation and ranging (SONAR) device, a magnetometer, an audio device, and/or other technologies used for positioning.

The UE apparatus 1102 may further include a wireless baseband processor 1126, which may be referred to as a modem. The wireless baseband processor 1126 may have on-chip memory 1126′. Along with, and similar to, the application processor 1106, the wireless baseband processor 1126 may also be coupled to the sensor(s) module 1112, the power supply 1114, the additional module of memory 1116, the camera 1118, and/or other related components. The wireless baseband processor 1126 may be additionally coupled to one or more subscriber identity module (SIM) card(s) 1120 and/or one or more transceivers 1130 (e.g., wireless RF transceivers).

Within the one or more transceivers 1130, the UE apparatus 1102 may include a Bluetooth module 1132, a WLAN module 1134, an SPS module 1136 (e.g., GNSS module), and/or a cellular module 1138. The Bluetooth module 1132, the WLAN module 1134, the SPS module 1136, and the cellular module 1138 may each include an on-chip transceiver (TRX), or in some cases, just a transmitter (TX) or just a receiver (RX). The Bluetooth module 1132, the WLAN module 1134, the SPS module 1136, and the cellular module 1138 may each include dedicated antennas and/or utilize antennas 1140 for communication with one or more other nodes. For example, the UE apparatus 1102 can communicate through the transceiver(s) 1130 via the antennas 1140 with another UE (e.g., sidelink communication) and/or with a network entity 104 (e.g., uplink/downlink communication), where the network entity 104 may correspond to a base station or a unit of the base station, such as the RU 106, the DU 108, or the CU 110.

The wireless baseband processor 1126 and the application processor 1106 may each include a computer-readable medium/memory 1126′, 1106′, respectively. The additional module of memory 1116 may also be considered a computer-readable medium/memory. Each computer-readable medium/memory 1126′, 1106′, 1116 may be non-transitory. The wireless baseband processor 1126 and the application processor 1106 may each be responsible for general processing, including execution of software stored on the computer-readable medium/memory 1126′, 1106′, 1116. The software, when executed by the wireless baseband processor 1126/application processor 1106, causes the wireless baseband processor 1126/application processor 1106 to perform the various functions described herein. The computer-readable medium/memory may also be used for storing data that is manipulated by the wireless baseband processor 1126/application processor 1106 when executing the software. The wireless baseband processor 1126/application processor 1106 may be a component of the UE 102. The UE apparatus 1102 may be a processor chip (e.g., modem and/or application) and include just the wireless baseband processor 1126 and/or the application processor 1106. In other examples, the UE apparatus 1102 may be the entire UE 102 and include the additional modules of the apparatus 1102.

As discussed in FIG. 1 and implemented with respect to FIG. 9, the UE-based CSI processing component 140 is configured to: receive, from a network entity, a configuration for an ML-based CSI report associated with a first CSI-RS; receive, from the network entity, the first CSI-RS; and transmit, to the network entity, the ML-based CSI report including CSI that is based on a UE capability for processing the ML-based CSI report in association with the first CSI-RS. The UE-based CSI processing component 140 may be within the application processor 1106 (e.g., at 140a), the wireless baseband processor 1126 (e.g., at 140b), or both the application processor 1106 and the wireless baseband processor 1126. The UE-based CSI processing component 140a-140b may be one or more hardware components specifically configured to carry out the stated processes/algorithm, implemented by one or more processors configured to perform the stated processes/algorithm, stored within a computer-readable medium for implementation by the one or more processors, or a combination thereof.

FIG. 12 is a diagram 1200 illustrating an example of a hardware implementation for one or more network entities 104. The one or more network entities 104 may be a base station, a component of a base station, or may implement base station functionality. The one or more network entities 104 may include, or may correspond to, at least one of the RU 106, the DU, 108, or the CU 110. The CU 110 may include a CU processor 1246, which may have on-chip memory 1246′. In some aspects, the CU 110 may further include an additional module of memory 1256 and/or a communications interface 1248, both of which may be coupled to the CU processor 1246. The CU 110 can communicate with the DU 108 through a midhaul link 162, such as an F1 interface between the communications interface 1248 of the CU 110 and a communications interface 1228 of the DU 108.

The DU 108 may include a DU processor 1226, which may have on-chip memory 1226′. In some aspects, the DU 108 may further include an additional module of memory 1236 and/or the communications interface 1228, both of which may be coupled to the DU processor 1226. The DU 108 can communicate with the RU 106 through a fronthaul link 160 between the communications interface 1228 of the DU 108 and a communications interface 1208 of the RU 106.

The RU 106 may include an RU processor 1206, which may have on-chip memory 1206′. In some aspects, the RU 106 may further include an additional module of memory 1216, the communications interface 1208, and one or more transceivers 1230, all of which may be coupled to the RU processor 1206. The RU 106 may further include antennas 1240, which may be coupled to the one or more transceivers 1230, such that the RU 106 can communicate through the one or more transceivers 1230 via the antennas 1240 with the UE 102.

The on-chip memory 1206′, 1226′, 1246′ and the additional modules of memory 1216, 1236, 1256 may each be considered a computer-readable medium/memory. Each computer-readable medium/memory may be non-transitory. Each of the processors 1206, 1226, 1246 is responsible for general processing, including execution of software stored on the computer-readable medium/memory. The software, when executed by the corresponding processor(s) 1206, 1226, 1246 causes the processor(s) 1206, 1226, 1246 to perform the various functions described herein. The computer-readable medium/memory may also be used for storing data that is manipulated by the processor(s) 1206, 1226, 1246 when executing the software. In examples, the network-based CSI processing component 150 may sit at any of the one or more network entities 104, such as at the CU 110; both the CU 110 and the DU 108; each of the CU 110, the DU 108, and the RU 106; the DU 108; both the DU 108 and the RU 106; or the RU 106.

As discussed in FIG. 1 and implemented with respect to FIG. 10, the network-based CSI processing component 150 is configured to: transmit, to a UE, a configuration for an ML-based CSI report associated with a first CSI-RS; transmit, to the UE, the first CSI-RS; and receive, from the UE, the ML-based CSI report including CSI that is based on a UE capability for processing the ML-based CSI report in association with the first CSI-RS. The network-based CSI processing component 150 may be within one or more processors of the one or more network entities 104, such as the RU processor 1206 (e.g., at 150a), the DU processor 1226 (e.g., at 150b), and/or the CU processor 1246 (e.g., at 150c). The network-based CSI processing component 150a-150c may be one or more hardware components specifically configured to carry out the stated processes/algorithm, implemented by one or more processors 1206, 1226, 1246 configured to perform the stated processes/algorithm, stored within a computer-readable medium for implementation by the one or more processors 1206, 1226, 1246, or a combination thereof.

The specific order or hierarchy of blocks in the processes and flowcharts disclosed herein is an illustration of example approaches. Hence, the specific order or hierarchy of blocks in the processes and flowcharts may be rearranged. Some blocks may also be combined or deleted. The accompanying method claims present elements of the various blocks in an example order, and are not limited to the specific order or hierarchy presented in the claims, processes, and flowcharts.

The detailed description set forth herein describes various configurations in connection with the drawings and does not represent the only configurations in which the concepts described herein may be practiced. The detailed description includes specific details for the purpose of providing a thorough explanation of various concepts. However, these concepts may be practiced without these specific details. In some instances, well known structures and components are shown in block diagram form in order to avoid obscuring such concepts.

Aspects of wireless communication systems, such as telecommunication systems, are presented with reference to various apparatuses and methods. These apparatuses and methods are described in the following detailed description and are illustrated in the accompanying drawings by various blocks, components, circuits, processes, call flows, systems, algorithms, etc. (collectively referred to as “elements”). These elements may be implemented using electronic hardware, computer software, or combinations thereof. Whether such elements are implemented as hardware or software depends upon the particular application and design constraints imposed on the overall system.

An element, or any portion of an element, or any combination of elements may be implemented as a “processing system” that includes one or more processors. Examples of processors include microprocessors, microcontrollers, graphics processing units (GPUs), central processing units, application processors, digital signal processors (DSPs), reduced instruction set computing (RISC) processors, systems-on-chip (SoC), baseband processors, field programmable gate arrays (FPGAs), programmable logic devices (PLDs), state machines, gated logic, discrete hardware circuits, and other similar hardware configured to perform the various functionality described throughout this disclosure. One or more processors in the processing system may execute software, which may be referred to as software, firmware, middleware, microcode, hardware description language, or otherwise. Software shall be construed broadly to mean instructions, instruction sets, code, code segments, program code, programs, subprograms, software components, applications, software applications, software packages, routines, subroutines, objects, executables, threads of execution, procedures, functions, or any combination thereof.

If the functionality described herein is implemented in software, the functions may be stored on, or encoded as, one or more instructions or code on a computer-readable medium, such as a non-transitory computer-readable storage medium. Computer-readable media includes computer storage media and can include a random-access memory (RAM), a read-only memory (ROM), an electrically erasable programmable ROM (EEPROM), optical disk storage, magnetic disk storage, other magnetic storage devices, combinations of these types of computer-readable media, or any other medium that can be used to store computer executable code in the form of instructions or data structures that can be accessed by a computer. Storage media may be any available media that can be accessed by a computer.

Aspects, implementations, and/or use cases described herein may be implemented across many differing platform types, devices, systems, shapes, sizes, and packaging arrangements. For example, the aspects, implementations, and/or use cases may come about via integrated chip implementations and other non-module-component based devices, such as end-user devices, vehicles, communication devices, computing devices, industrial equipment, retail/purchasing devices, medical devices, AI-enabled devices, ML-enabled devices, etc. The aspects, implementations, and/or use cases may range from chip-level or modular components to non-modular or non-chip-level implementations, and further to aggregate, distributed, or original equipment manufacturer (OEM) devices or systems incorporating one or more techniques described herein.

Devices incorporating the aspects and features described herein may also include additional components and features for the implementation and practice of the claimed and described aspects and features. For example, transmission and reception of wireless signals necessarily includes a number of components for analog and digital purposes, such as hardware components, antennas, RF-chains, power amplifiers, modulators, buffers, processor(s), interleavers, adders/summers, etc. Techniques described herein may be practiced in a wide variety of devices, chip-level components, systems, distributed arrangements, aggregated or disaggregated components, end-user devices, etc., of varying configurations.

The description herein is provided to enable a person skilled in the art to practice the various aspects described herein. Various modifications to these aspects will be readily apparent to those skilled in the art, and the generic principles defined herein may be applied to other aspects. Thus, the claims are not limited to the aspects described herein, but are to be interpreted in view of the full scope of the present disclosure consistent with the language of the claims.

Reference to an element in the singular does not mean “one and only one” unless specifically stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. Unless specifically stated otherwise, the term “some” refers to one or more. Combinations such as “at least one of A, B, or C” or “one or more of A, B, or C” include any combination of A, B, and/or C, such as A and B, A and C, B and C, or A and B and C, and may include multiples of A, multiples of B, and/or multiples of C, or may include A only, B only, or C only. Sets should be interpreted as a set of elements where the elements number one or more.

Structural and functional equivalents to elements of the various aspects described throughout this disclosure that are known or later come to be known to those of ordinary skill in the art are expressly incorporated herein by reference and are encompassed by the claims. The words “module,” “mechanism,” “element,” “device,” and the like may not be a substitute for the word “means.” As such, no claim element is to be construed as a means plus function unless the element is expressly recited using the phrase “means for.” As used herein, the phrase “based on” shall not be construed as a reference to a closed set of information, one or more conditions, one or more factors, or the like. In other words, the phrase “based on A”, where “A” may be information, a condition, a factor, or the like, shall be construed as “based at least on A” unless specifically recited differently.

The following examples are illustrative only and may be combined with other examples or teachings described herein, without limitation.

Example 1 is a method of wireless communication at a UE, including: receiving, from a network entity, a configuration for an ML-based CSI report associated with a first CSI-RS; receiving, from the network entity, the first CSI-RS; and transmitting, to the network entity, the ML-based CSI report including CSI that is based on a UE capability for processing the ML-based CSI report in association with the first CSI-RS.

Example 2 may be combined with Example 1 and includes that the UE capability for processing the ML-based CSI report includes a first capability for simultaneously processing a plurality of ML-based CSI reports including the ML-based CSI report.

Example 3 may be combined with any of Examples 1-2 and includes that the UE capability for processing the ML-based CSI report includes a second capability for simultaneously processing the ML-based CSI report and a non-ML-based CSI report.

Example 4 may be combined with any of Examples 1-3 and includes that the UE capability for processing the ML-based CSI report includes a third capability for processing the ML-based CSI report according to a threshold processing delay.

Example 5 may be combined with any of Examples 1-4 and further includes transmitting, to the network entity, a UE capability message indicating the UE capability for processing the ML-based CSI report.

Example 6 may be combined with any of Examples 1-5 and further includes receiving, from the network entity, a triggering indication for at least one of: the ML-based CSI report, the plurality of ML-based CSI reports including the ML-based CSI report, or the ML-based CSI report and the non-ML-based CSI report.

Example 7 may be combined with any of Examples 1-6 and includes that the CSI included in the ML-based CSI report is based on the first CSI-RS when the UE has the UE capability for processing the ML-based CSI report in association with the first CSI-RS.

Example 8 may be combined with any of Examples 1-6 and includes that the CSI included in the ML-based CSI report is based on a second CSI-RS different from the first CSI-RS when the UE does not have the UE capability for processing the ML-based CSI report in association with the first CSI-RS; and the method further including receiving, from the network entity, the second CSI-RS prior to receiving the first CSI-RS.

Example 9 may be combined with Example 8 and includes that the ML-based CSI report that includes the CSI based on the second CSI-RS is a first CSI report that the UE simultaneously processes with a second CSI report of higher priority than the first CSI report, the UE being capable of simultaneously processing the first CSI report based on the second CSI-RS and the second CSI report based on the first CSI-RS, but not capable of simultaneously processing both the first CSI report and the second CSI report based on the first CSI-RS.

Example 10 may be combined with any of Examples 1-9 and includes that the transmitting the ML-based CSI report, includes: transmitting, to the network entity, an indication of whether the CSI included in the ML-based CSI report is based on the first CSI-RS or the second CSI-RS.

Example 11 is a method of wireless communication at a network entity, including: transmitting, to a UE, a configuration for an ML-based CSI report associated with a first CSI-RS; transmitting, to the UE, the first CSI-RS; and receiving, from the UE, the ML-based CSI report including CSI that is based on a UE capability for processing the ML-based CSI report in association with the first CSI-RS.

Example 12 may be combined with Example 11 and further includes receiving, from the UE, a UE capability message indicating that the UE capability for processing the ML-based CSI report includes at least one of: a first capability for simultaneously processing a plurality of ML-based CSI reports including the ML-based CSI report, a second capability for simultaneously processing the ML-based CSI report and a non-ML-based CSI report, or a third capability for processing the ML-based CSI report according to a threshold processing delay.

Example 13 may be combined with any of Examples 11-12 and further includes transmitting, to the UE, a triggering indication for at least one of: the ML-based CSI report, the plurality of ML-based CSI reports including the ML-based CSI report, or the ML-based CSI report and the non-ML-based CSI report.

Example 14 may be combined with any of Examples 11-13 and includes that the CSI included in the ML-based CSI report is based on the first CSI-RS when the UE has the UE capability for processing the ML-based CSI report in association with the first CSI-RS.

Example 15 may be combined with any of Examples 11-13 and includes that the CSI included in the ML-based CSI report is based on a second CSI-RS different from the first CSI-RS when the UE does not have the UE capability for processing the ML-based CSI report in association with the first CSI-RS; and the method further includes transmitting, to the UE, the second CSI-RS prior to transmitting the first CSI-RS.

Example 16 may be combined with Example 15 and includes that the ML-based CSI report that includes the CSI based on the second CSI-RS is a first CSI report that the UE simultaneously processes with a second CSI report of higher priority than the first CSI report, the UE being capable of simultaneously processing the first CSI report based on the second CSI-RS and the second CSI report based on the first CSI-RS, but not capable of simultaneously processing both the first CSI report and the second CSI report based on the first CSI-RS.

Example 17 may be combined with any of Examples 11-16 and includes that the receiving the ML-based CSI report, includes: receiving, from the UE, an indication of whether the CSI included in the ML-based CSI report is based on the first CSI-RS or the second CSI-RS.

Example 18 is an apparatus for wireless communication for implementing a method as in any of Examples 1-17.

Example 19 is an apparatus for wireless communication including means for implementing a method as in any of Examples 1-17.

Example 20 is a non-transitory computer-readable medium storing computer executable code, the code when executed by at least one processor causes the at least one processor to implement a method as in any of examples 1-17.

1-16. (canceled)

17. A method of wireless communication at a user equipment (UE), comprising:
receiving, from a network entity, a configuration for a machine learning (ML)-based channel state information (CSI) report associated with a first channel state information-reference signal (CSI-RS);
receiving, from the network entity, the first CSI-RS; and
transmitting, to the network entity, the ML-based CSI report including CSI that is based on a UE capability for processing the ML-based CSI report in association with the first CSI-RS.

18. The method of claim 17, wherein the UE capability for processing the ML-based CSI report includes at least one of:
a first capability for simultaneously processing a plurality of ML-based CSI reports including the ML-based CSI report,
a second capability for simultaneously processing the ML-based CSI report and a non-ML-based CSI report, or
a third capability for the processing the ML-based CSI report according to a threshold processing delay.

19. The method of claim 17, further comprising:
transmitting, to the network entity, a UE capability message indicating the UE capability for processing the ML-based CSI report.

20. The method of claim 17, further comprising:
receiving, from the network entity, a triggering indication for at least one of:
the ML-based CSI report,
a plurality of ML-based CSI reports including the ML-based CSI report, or
the ML-based CSI report and a non-ML-based CSI report.

21. The method of claim 17, wherein the CSI included in the ML-based CSI report is based on the first CSI-RS when the UE has the UE capability for processing the ML-based CSI report in association with the first CSI-RS.

22. The method of claim 17, wherein
the CSI included in the ML-based CSI report is based on a second CSI-RS different from the first CSI-RS when the UE does not have the UE capability for processing the ML-based CSI report in association with the first CSI-RS, and
the method further comprises receiving, from the network entity, the second CSI-RS prior to receiving the first CSI-RS.

23. The method of claim 22, wherein the ML-based CSI report that includes the CSI based on the second CSI-RS is a first CSI report that the UE simultaneously processes with a second CSI report of higher priority than the first CSI report, the UE being capable of simultaneously processing the first CSI report based on the second CSI-RS and the second CSI report based on the first CSI-RS, but not capable of simultaneously processing both the first CSI report and the second CSI report based on the first CSI-RS.

24. The method of claim 17, wherein the transmitting the ML-based CSI report, comprises:
transmitting, to the network entity, an indication of whether the CSI included in the ML-based CSI report is based on the first CSI-RS or the second CSI-RS.

25. A method of wireless communication at a network entity, comprising:
transmitting, to a user equipment (UE), a configuration for a machine learning (ML)-based channel state information (CSI) report associated with a first channel state information-reference signal (CSI-RS);
transmitting, to the UE, the first CSI-RS; and
receiving, from the UE, the ML-based CSI report including CSI that is based on a UE capability for processing the ML-based CSI report in association with the first CSI-RS.

26. The method of claim 25, further comprising:
receiving, from the UE, a UE capability message indicating that the UE capability for processing the ML-based CSI report includes at least one of:
a first capability for simultaneously processing a plurality of ML-based CSI reports including the ML-based CSI report,
a second capability for simultaneously processing the ML-based CSI report and a non-ML-based CSI report, or
a third capability for processing the ML-based CSI report according to a threshold processing delay.

27. The method of claim 25, wherein the CSI included in the ML-based CSI report is based on the first CSI-RS when the UE has the UE capability for processing the ML-based CSI report in association with the first CSI-RS.

28. The method of claim 25, wherein
the CSI included in the ML-based CSI report is based on a second CSI-RS different from the first CSI-RS when the UE does not have the UE capability for processing the ML-based CSI report in association with the first CSI-RS, and
the method further comprises transmitting, to the UE, the second CSI-RS prior to transmitting the first CSI-RS.

29. The method of claim 25, wherein the receiving the ML-based CSI report, comprises:
receiving, from the UE, an indication of whether the CSI included in the ML-based CSI report is based on the first CSI-RS or the second CSI-RS.

30. An apparatus for wireless communication at a user equipment, comprising: a memory; a transceiver; and a processor coupled to the memory and the transceiver, the processor being configured to cause the transceiver to:
receive, from a network entity, a configuration for a machine learning (ML)-based channel state information (CSI) report associated with a first channel state information-reference signal (CSI-RS);
receive, from the network entity, the first CSI-RS; and
transmit, to the network entity, the ML-based CSI report including CSI that is based on a UE capability for processing the ML-based CSI report in association with the first CSI-RS.

31. The apparatus of claim 30, wherein the UE capability for processing the ML-based CSI report includes at least one of:
a first capability for simultaneously processing a plurality of ML-based CSI reports including the ML-based CSI report,
a second capability for simultaneously processing the ML-based CSI report and a non-ML-based CSI report, or
a third capability for the processing the ML-based CSI report according to a threshold processing delay.

32. The apparatus of claim 30, wherein the processor is further configured to cause the transceiver to:
transmit, to the network entity, a UE capability message indicating the UE capability for processing the ML-based CSI report.

33. The apparatus of claim 30, wherein the processor is further configured to cause the transceiver to:
receive, from the network entity, a triggering indication for at least one of:
the ML-based CSI report,
a plurality of ML-based CSI reports including the ML-based CSI report, or
the ML-based CSI report and a non-ML-based CSI report.

34. The apparatus of claim 30, wherein the CSI included in the ML-based CSI report is based on the first CSI-RS when the UE has the UE capability for processing the ML-based CSI report in association with the first CSI-RS.

35. The apparatus of claim 30, wherein
the CSI included in the ML-based CSI report is based on a second CSI-RS different from the first CSI-RS when the UE does not have the UE capability for processing the ML-based CSI report in association with the first CSI-RS, and
the processor is further configured to cause the transceiver to receive, from the network entity, the second CSI-RS prior to receiving the first CSI-RS.

36. The apparatus of claim 35, wherein the ML-based CSI report that includes the CSI based on the second CSI-RS is a first CSI report that the UE simultaneously processes with a second CSI report of higher priority than the first CSI report, the UE being capable of simultaneously processing the first CSI report based on the second CSI-RS and the second CSI report based on the first CSI-RS, but not capable of simultaneously processing both the first CSI report and the second CSI report based on the first CSI-RS.
